(19) United States
(12) Patent Application Publication
(10) Pub. No.: US 2013/0291496 A1
(43) Pub. Date: Nov. 7, 2013

(54) Free Shoulder Panel Saddle

(71) Applicant: Bernardo Vergara, Morriston, FL (US)

(72) Inventor: Bernardo Vergara, Morriston, FL (US)

(21) Appl. No.: 13/465,062

(22) Filed: May 7, 2012

(51) Int. Cl. B68C 1/02

(52) U.S. Cl. 54/44.1

(57) ABSTRACT

The inventive saddle incorporates a padded “free shoulder” panel with a reduced thickness forward section that is configured to provide a physical barrier between the saddle tree and saddle outer flaps and the horse's scapula, while preventing substantial weight transfer onto the scapula or other deleterious contact with the scapula and horse shoulder area. The reduced impact on the horse's body and freed shoulder movement improves horse performance and health.

### BACKGROUND OF THE INVENTION

The present invention pertains to saddles for horse back riding. In the prior art, saddles incorporate a flexible or rigid frame, sometimes called a “tree”, that is the main structural component of the saddle and functions to properly distribute the riders weight on top of the horse, and to provide a comfortable and functional seat base for the rider. Typically, flexible flaps are attached to the tree to extend over the horse's sides to receive the rider's leg and provide a continuing connection to the horse.

To provide adjustment to the horse's shape and further accommodate weight distribution, padded panels are located underneath the tree and the flaps. Various other elements may be provided or incorporated into the tree, flaps or panels.

It is critical for proper riding and the health of the horse that the saddle bears on particular portions of the horse anatomy and does not impinge on the spine, adjacent connective tissue, and the primary motive muscles and joints.

Due to demands for effective balance and performance for both horse and rider during activities such as jumping and polo, the common practice is for saddles to be mounted forward such that the tree and, or, the panels bear onto the top of the horse's shoulder blade (scapula) and the overlying muscles there. As a result, the horse's shoulders are compromised resulting in discomfort that may affect its performance and such pressure may cause injury.

What is desired is a saddle design that will provide a forward balance for the rider performance as well as maintain a proper fit behind the shoulder of the horse to ensure its maximum athletic capabilities.

### SUMMARY OF THE INVENTION

The present invention is a saddle incorporating a padded “free shoulder” panel with a reduced thickness forward section that is configured to provide a physical barrier between the saddle tree and saddle outer flaps and the horses shoulder, while preventing substantial weight or force transfer onto the scapula or other deleterious contact with the scapula and horse shoulder area.

The inventive saddle includes a conventional tree frame and outer flaps that separate the rider from the horse and provide a foundation for the rider. A novel inner padded panel has a main portion that bears on the horse and provides cushioning beneath the tree and flaps to distribute rider weight. The inner panel also includes a free shoulder panel portion, forward of the tree, that is positioned and configured to overlay the horse's shoulder without transferring weight to the shoulder or substantially contacting the horse's protruding scapula. This forward panel portion is reduced in thickness, relative to the main panel portion, such that a spacial gap results between the horse's scapula and the saddle tree and flaps.

The inventive saddle can be fit to a horse in a manner that it will allow free shoulder movement of the horse's shoulder and scapula while providing the desired riding position and attitude desire by active riders. In this way, the present inventive saddle provides a novel combination of horse health and rider performance that has been long sought.

Additional novel aspects and benefits of the invention will be discerned from the following description of particular embodiments and the accompanying figures.

### DESCRIPTION OF THE DRAWINGS

FIG. 1 is a side view illustration of one embodiment of the invention shown with the various elements separated.

FIG. 2 is a front view of the assembled elements of FIG. 1.

### DETAILED DESCRIPTION OF EMBODIMENTS OF THE INVENTION

Herein, the term “shoulder” is used to indicate the area of a horse's body at and immediately surrounding the top of the scapula. This area is generally visually indicated by a prominence on the body surface—on horses having healthy muscle mass. With respect to the contact with a saddle, the rearward portion of this area is more particularly intended as the shoulder.

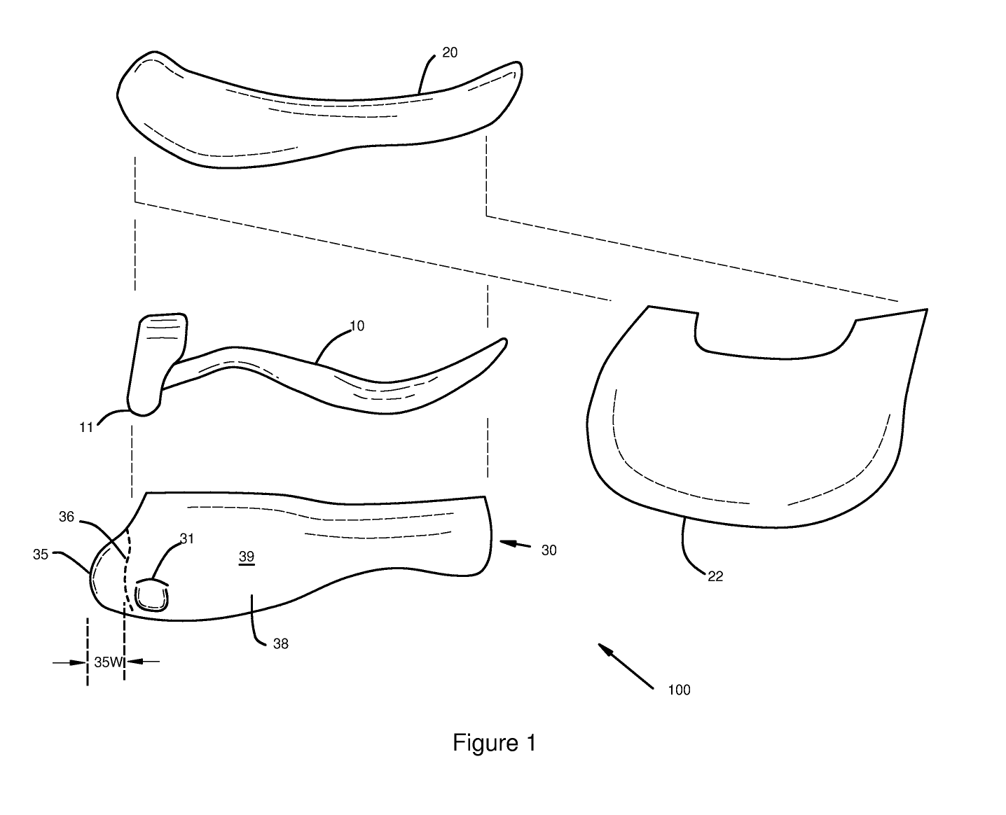

FIG. 1 illustrated the components of a saddle 100 according to the invention. The elements of the saddle are shown separated to make the relevant portions visible. The saddle is constructed about a rigid open frame structure commonly referred to in the industry as a “tree” 10. The construction of the tree 10 shown is typical of many designs used for the same purpose in saddles designed for jumping and polo use. The tree 10 includes, on each side, a front piece called the point of the tree 11 that extends, cantilevered, downward and outward. As is typical, each point of the tree 11 is flat in form to fit between the various layers of the saddle. The overall shape and form of the tree 10 may vary or be adjustable as necessary to accommodate the particular form of the horse the saddle is to be used with.

The particular construction of the tree 10 is not critical to the invention but should provide the proper rigidity needed to prevent changes in the tree due to age and work. Trees made with wood and metal, or solid trees of molded construction may be used as well as other constructions providing the same characteristics and function.

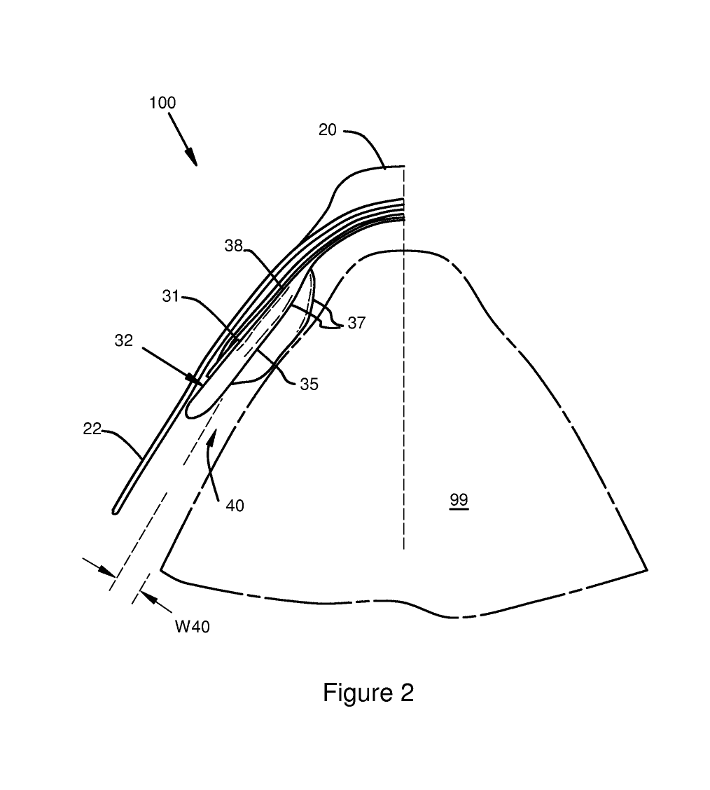

Overlaying the tree 10 is a saddle seat 20 with attached flaps 22 that drop below both sides of the tree 10. In the side view of FIG. 1, only one flap 22 is viewable, but it will be clear to the reader that the saddle 100 is symmetric with either one or more flaps 22 on each side in conventional manner (see FIG. 2). For clarity, the visible flap 22 in FIG. 1 is shown separated from the upper portion of the seat 20. The seat 20 is configured to receive a human rider in seated orientation. The seat 20 and flaps 22 are shown in simple form and may include, in various optional configurations, other elements such as are found on conventional saddles. The seat 20 is preferably formed of leather although this is not a restriction in the invention.

A padded panel 30 is configured to be placed under the tree 10 and flap 22 to provide a softer element of contact with the horse's body, and to conform the saddle to the shape of a horse's body. The general construction of the (“free shoulder panel”) panel 30 may follow conventional design and is preferably formed of a lower (inner) sheet layer 37 and separate upper (outer) sheet layer 38 separated by internal spaces or pockets extending the length of tree 10 and flaps 22. The upper and lower layers are joined by stitching along the perimeter or by other conventional or equivalent methods. The internal spaces between the two layers 37, 38 are filled with compressible stuffing or foam and may be customized to adjust the three-dimensional thickness and shape of the panel 30. The two layers 37 and 38 are preferably each formed of leather and felt, but may be formed of other materials having the same properties.

Near the forward end of the panel 30 and on the upper (exterior) surface 32 of the panel 30, the panel 30 includes an external open pocket 31 shaped to snugly receive the point of the tree 11. The point of the tree 11 passes into the upper pocket 31 so that the interference of the pocket and panel 30 holding the point of the tree 11 at the pocket opening 31 provides a means of securing the tree 10 and panel 30 together. In this manner, the local surrounding portion of the panel 30 is also fixed in place by the rigidity of the tree 10. Other constructions or attachment devices may be used in a similar manner to secure the point of the tree 11 and panel 30 for the same result. For example, the panel outer layer 38 may include an external slit allowing the point of the tree 11 to pass into the panel 30 itself—without separate external structure. Other attachment devices and methods may also be used.

At the forward extent of the panel 30, and adjacent and entirely forward of the external pocket 31, the panel 30 includes a reduced thickness shoulder support section 35. This shoulder support section 35 is preferably formed by stitching the inner and outer panel layers 37, 38 together by a generally vertical line of conventional stitching thereby compressing them together and reducing their combined thickness. The stitching line 36 should be oriented generally parallel to, and slightly behind, the back of the horse's shoulder. The stitching line 36 defines a boundary between the shoulder support section 35 and a back support section 39 of the panel 30. During compression and stitching, the inner layer 37 is displaced towards the outer layer 38 (see FIG. 2). In contrast, simple symmetric compression of both inner and outer layers 37, 38 towards each other will likely not provide adequate gap between the shoulder support section 35 and the horse. To enable the desired asymmetric compression of the inner layer 37 towards the outside, it may be necessary that the inner layer 37 be formed of substantially thinner or more flexible material. The thickness of the combined inner layer 37, outer layer 38, and any padding between, should be in the in range of 0.25 to 0.5 inches (6.3 to 12.6 millimeters).

While the shoulder support section 35 is preferably formed by the compression of the stitching line 36, other means of compressing and securing together the layers of the panel 30 may also be used. For example, a series of discrete through-fasteners may accomplish the same result.

The back support section 39 of the panel 30, behind the stitch line 36, preferably has a greater thickness than that of the shoulder support section 35, and not less than 1.50 inches (38.1 millimeters) nominally, in order to receive almost all the weight from the saddle and rider.

FIG. 2 is a front view of the saddle 100 on a section outline 99 of a horse body. As illustrated in FIG. 2, the compression and movement of the inner layer 37 outward toward the outer layer 38 (and resultant reduced thickness as compared to that of the back support section 39) results in a gap 40 between the horses's body and the shoulder support section 35. This gap 40 has a width dimension W40 defined as the orthogonal distance from the approximate center of the inside surface of the shoulder support section 35 to the facing surface of the horse. This may be approximated by the reduction in thickness of the support section 35 from that of the adjacent portions of the support section 39. It will be understood that while the thickness of support section 39 may vary infinitely in part by the shape of its inside surface, the effective thickness in any area of the support section 39 is defined by the nominal inside plane of areas of maximum thickness immediate adjacent the area, that limit and determine the position of the saddle. Likewise the gap 40 is determined by this same plane.

With proper fit of the saddle and sufficient gap 40, the saddle may be maintained secure on the horse and give the rider a desirable seat location while allowing the horse's shoulder freedom to move without pressure or hindrance. The gap dimension W40 must be at least 0.5 inches (12.7 millimeters) to be effective. Depending on a particular horse's body geometry, the gap dimension W40 may necessarily be as great as 1.5 inches (38.1 millimeters) or more.

When the saddle is properly fit on a horse, the gap 40 provides for the protruding shoulder muscle and bone configuration, that the saddle's shoulder support section 35 overlays. While generally separated from the horse, the shoulder support section 35 provides a shield and barrier to incidental contact of the other elements of the saddle with the horse preventing abrasion and acute injuries. “Proper fit” of a saddle is defined as when the saddle is placed symmetrically on the horse's back with the point of the tree 11 located just rearward of the prominence of the horse's scapula.

The saddle's shoulder support section 35 of the invention may be variously shaped and extend forward of the point of the tree 11 differing amounts on different configurations of the invention. However, to ensure proper fit and rider's comfort the shoulder support section 35 preferably extends a panel free shoulder length dimension 35 W at least 1.25 inches (31.7 millimeters) in a forward direction from the boundary stitching line 36. This is a minimum dimension that will provide the protective function of the free shoulder panel element over the horse shoulder without the shoulder support section bearing on the horse's shoulder or otherwise transmitting force onto the horse. The shoulder length dimension may be substantially greater.

It should be clear from the above description that the seat elements including the flap 22 must all be unattached and free from the shoulder portion 35 to allow these elements to move away from the horse's shoulder during use.

Herein the terms “forward” and “rearward” and like terms are intended to convey relative locations and directions with respect to the normal centerline facing direction of a horse on which the saddle is mounted in normal use.

The preceding discussion is provided for example only. Other variations of the claimed inventive concepts will be obvious to those skilled in the art. Adaptation or incorporation of known alternative devices and materials, present and future is also contemplated. The intended scope of the invention is defined by the following claims.

1. A horse saddle comprising:
a rigid saddle tree including two point elements extending symmetrically downward;
a seat secured to the tree and configured to receive a human rider above the tree;
at least two flaps, at least one flap secured to and extending downward from each side of the seat;
a panel configured to compressibly conform to the tree and a horse's back when the saddle is place symmetrically on the horse's back; the panel including two open pockets, each configured to receive a respective tree point element;
the panel further comprising two free shoulder portions, each extending forward of a respective open pocket;
the free shoulder portions having a reduced thickness such as to form a gap between the free shoulder portion and a horse in a condition when the saddle is oriented on the horse with the free shoulder portions overlaying the scapulas of the horse.

2. A horse saddle, according to claim 1, and wherein:
the free shoulder portions have a thickness in the range of 0.25 to 0.50 inches and the panel in other portions has a thickness of at least 1.5 inches.

3. A horse saddle, according to claim 2, and wherein:
the free shoulder portion extends forward of the tree point a dimension of at least 1.25 inches.

4. A horse saddle, comprising:
a rigid saddle tree including two point elements extending symmetrically downward;
a seat secured to the tree and configured to receive a human rider above the tree;
at least two flaps, at least one flap secured to and extending downward from each side of the seat;
a panel configured to compressibly conform to the tree and a horse's back when the saddle is place symmetrically on the horse's back;
a securing means for securing each tree point element to the panel;
the panel having a nominal thickness adjacent the tree point element when the panel is secured to the tree;
the panel further comprising two free shoulder portions, each extending forward from a vertical boundary of the panel adjacent a respective tree point element;
the free shoulder portions each having a shoulder portion thickness equal to at least 0.5 inches less than the panel nominal thickness.

5. A saddle, according to claim 4, and wherein:
the free shoulder portions extend forward sufficiently to intervene between the flaps and a horse's scapula when the saddle is located on the horse with the vertical boundary behind the scapula.

6. An improved saddle having a padded panel secured under a tree-stiffened seat, in which the improvement comprises:
a reduced thickness portion of the panel configured to overlay a horse's scapula without exerting force onto the scapula while other portions of the panel support the saddle on the horse.
